(19) United States
(12) Patent Application Publication
(10) Pub. No.: US 2025/0190834 A1
(43) Pub. Date: Jun. 12, 2025

(54) SOLVING INEQUALITY CONSTRAINED OPTIMIZATION PROBLEM ON HYBRID QUANTUM-CLASSICAL COMPUTING SYSTEM

(71) Applicant: IONQ, INC., College Park, MD (US)

(72) Inventor: Ananth Prakash KAUSHIK, Santa Clara, CA (US)

(21) Appl. No.: 18/423,208

(22) Filed: Jan. 25, 2024

Related U.S. Application Data
(60) Provisional application No. 63/449,298, filed on Mar. 1, 2023.

(51) Int. Cl. G06N 10/60; G06N 10/20

(52) U.S. Cl. CPC G06N 10/60; G06N 10/20

(57) ABSTRACT

A method of performing computation in a hybrid quantum-classical computing system includes computing an approximate cost function of an optimization problem with variables constrained by an inequality, wherein the inequality constraint is included using a polynomial approximation of a Heaviside step function, mapping the approximate cost function of the optimization problem to a model Hamiltonian, setting a quantum processor in an initial state, executing one or more iterations, each iteration including applying a parametrized quantum circuit to the quantum processor based on a set of variational parameters and the model Hamiltonian, measuring an expectation value of the model Hamiltonian, and replacing the set of the variational parameters with another set of variational parameters, and outputting the set of the variational parameters after executing the one or more iterations.

### CROSS-REFERENCE TO RELATED APPLICATIONS

This application claims priority to U.S. Provisional Application Ser. No. 63/449,298 filed Mar. 1, 2023, which is herein incorporated by reference in its entirety.

### BACKGROUND

### Field

The present disclosure generally relates to a method of performing computation in a hybrid quantum-classical computing system, and more specifically, to a method of solving an inequality constrained optimization problem in a hybrid computing system that includes a classical computer and a quantum computer that includes trapped ions.

### Description of the Related Art

In current state-of-the-art quantum computers, control of qubits is imperfect (noisy) and the number of qubits used in these quantum computers generally range from a hundred qubits to thousands of qubits. The number of quantum gates that can be used in such a quantum computer (referred to as a “noisy intermediate-scale quantum device” or “NISQ device”) to construct circuits to run an algorithm within a controlled error rate is limited due to the noise.

For solving some optimization problems, a NISQ device having shallow circuits (with small number of gate operations to be executed in time-sequence) can be used in combination with a classical computer (referred to as a hybrid quantum-classical computing system). For example, a classical computer (also referred to as a “classical optimizer”) instructs a controller to execute quantum gate operations on a NISQ device (also referred to as a “quantum processor”) and measure an outcome of the quantum processor. Subsequently, the classical optimizer instructs the controller to prepare the quantum processor in a slightly different state, and repeats execution of the gate operation and measurement of the outcome. This cycle is repeated until the approximate solution can be extracted. Such hybrid quantum-classical computing system having an NISQ device may outperform classical computers in finding approximate solutions to such optimization problems.

An optimization problem with variables constrained by an inequality is typically solved by introducing slack variables to convert an inequality constraint to an equality constraint. However, when mapping the optimization problem onto a quantum processor, the introduced slack variables need to be mapped onto qubits of the quantum processor. Thus, the number of qubits can grow quickly and varies depending on the inequality constraint.

Therefore, there is a need for improved methods for solving inequality constrained optimization problems on a hybrid quantum-classical computing system.

### SUMMARY

Embodiments of the present disclosure provide a method of performing computation in a hybrid quantum-classical computing system including a classical computer and a quantum processor. The method includes computing, by a classical computer, an approximate cost function of an optimization problem with variables constrained by an inequality, wherein the inequality constraint is included using a polynomial approximation of a Heaviside step function, mapping, by the classical computer, the approximate cost function of the optimization problem to a model Hamiltonian to be implemented on a quantum processor including a plurality of trapped ions, each of which has two hyperfine states defining a qubit, selecting, by the classical computer, a set of variational parameters to construct a parametrized quantum circuit including an entangling circuit based on the model Hamiltonian and a mixing circuit, setting, by a system controller, the quantum processor in an initial state, executing one or more iterations, each iteration including applying, by the system controller, the parametrized quantum circuit to the quantum processor based on the set of the variational parameters and the model Hamiltonian, to transform the quantum processor to a trial state, measuring, by the system controller, an expectation value of the model Hamiltonian, and replacing, by the classical computer, the set of the variational parameters with another set of variational parameters, if a difference between the measured expectation value of the model Hamiltonian and the expectation value of the model Hamiltonian measured in a previous iteration is more than a predetermined value, and outputting, by the classical computer, the set of the variational parameters after executing the one or more iterations.

Embodiments of the present disclosure also provide a hybrid quantum-classical computing system. A hybrid quantum-classical computing system includes a quantum processor including a plurality of trapped ions, each of the trapped ions having two hyperfine states defining a qubit, one or more lasers configured to emit a laser beam, which is provided to trapped ions in the quantum processor, and a classical computer configured to compute an approximate cost function of an optimization problem with variables constrained by an inequality, wherein the inequality constraint is included using a polynomial approximation of a Heaviside step function, map the approximate cost function of the optimization problem to a model Hamiltonian to be implemented on the quantum processor, select a set of variational parameters to construct a parametrized quantum circuit including an entangling circuit based on the model Hamiltonian and a mixing circuit, control a system controller to set the quantum processor in an initial state, execute one or more iterations, each iteration including control the system controller to apply the parametrized quantum circuit to the quantum processor based on the set of the variational parameters and the model Hamiltonian, to transform the quantum processor to a trial state, control the system controller to measure an expectation value of the model Hamiltonian, and replace the set of the variational parameters with another set of variational parameters, if a difference between the measured expectation value of the model Hamiltonian and the expectation value of the model Hamiltonian measured in a previous iteration is more than a predetermined value, and output the set of the variational parameters after executing the one or more iterations.

Embodiments of the present disclosure further provide a hybrid quantum-classical computing system including non-volatile memory having a number of instructions stored therein. The number of instructions, when executed by one or more processors, causes the hybrid quantum-classical computing system to perform operations including computing, by a classical computer, an approximate cost function of an optimization problem with variables constrained by an inequality, wherein the inequality constraint is included using a polynomial approximation of a Heaviside step function, mapping, by the classical computer, the approximate cost function of the optimization problem to a model Hamiltonian to be implemented on a quantum processor including a plurality of trapped ions, each of which has two hyperfine states defining a qubit, selecting, by the classical computer, a set of variational parameters to construct a parametrized quantum circuit including an entangling circuit based on the model Hamiltonian and a mixing circuit, setting, by a system controller, the quantum processor in an initial state, executing one or more iterations, each iteration including applying, by the system controller, the parametrized quantum circuit to the quantum processor based on the set of the variational parameters and the model Hamiltonian, to transform the quantum processor to a trial state, measuring, by the system controller, an expectation value of the model Hamiltonian, and replacing, by the classical computer, the set of the variational parameters with another set of variational parameters, if a difference between the measured expectation value of the model Hamiltonian and the expectation value of the model Hamiltonian measured in a previous iteration is more than a predetermined value, and outputting, by the classical computer, the set of the variational parameters after executing the one or more iterations.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic partial view of an ion trap quantum computing system according to one embodiment.

FIG. 2A depicts a schematic energy diagram of each ion in an ion chain according to one embodiment.

FIG. 2B depicts a schematic motional sideband spectrum of an ion in an ion chain according to one embodiment.

FIG. 3 depicts a flowchart illustrating a method 300 of obtaining a solution to an inequality constrained optimization problem by a quantum variational method, according to one embodiment.

FIG. 4A illustrates an inequality constraint, according to one embodiment.

FIG. 4B illustrates an inequality constraint, according to one embodiment.

FIG. 4C illustrates polynomial approximations of the Heaviside step function, according to one embodiment.

FIGS. 5A, 5B, 5C, and 5D illustrate quantum circuits that implements terms in an entangling circuit, according to one embodiment.

To facilitate understanding, identical reference numerals have been used, where possible, to designate identical elements that are common to the figures. In the figures and the following description, an orthogonal coordinate system including an X-axis, a Y-axis, and a Z-axis is used. The directions represented by the arrows in the drawing are assumed to be positive directions for convenience. It is contemplated that elements disclosed in some embodiments may be beneficially utilized on other implementations without specific recitation.

### DETAILED DESCRIPTION

Embodiments described herein are generally related to a method and a system for performing a computation using a hybrid quantum-classical computing system, and, more specifically, to providing an approximate solution to an optimization problem with one or more inequality constrains using a hybrid quantum-classical computing system that includes an ion chain including trapped ions.

### General Hardware Configurations

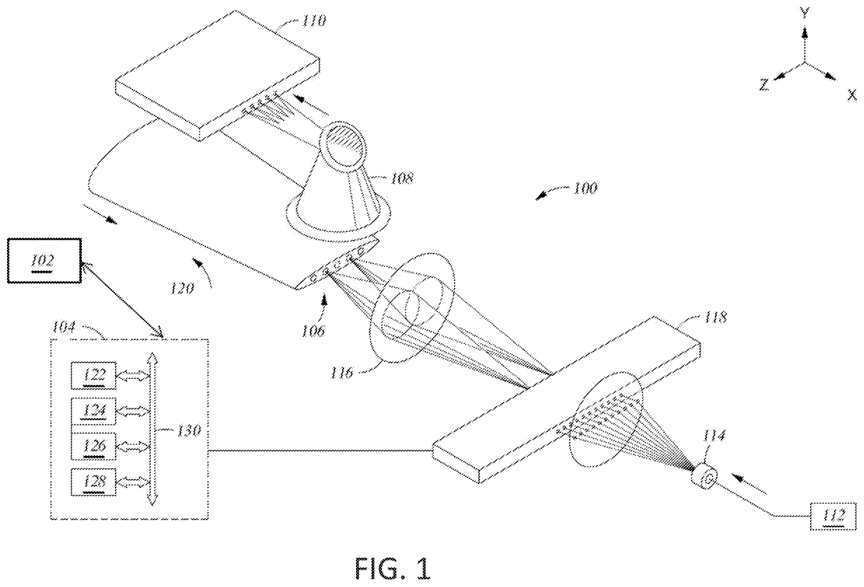

FIG. 1 is a schematic partial view of an ion trap quantum computing system, or system 100, according to one embodiment. The system 100 includes a classical (digital) computer 102, a system controller 104 and a quantum processor that is an ion chain106 having trapped ions (i.e., five shown) that extend along the Z-axis. The classical computer 102 includes a central processing unit (CPU), memory, and support circuits (or I/O). The memory is connected to the CPU, and may be one or more of a readily available memory, such as a read-only memory (ROM), a random access memory (RAM), floppy disk, hard disk, or any other form of digital storage, local or remote. Software instructions, algorithms and data can be coded and stored within the non-volatile memory for instructing the CPU. The support circuits (not shown) are also connected to the CPU for supporting the processor in a conventional manner. The support circuits may include conventional cache, power supplies, clock circuits, input/output circuitry, subsystems, and the like.

An imaging objective 108, such as an objective lens with a numerical aperture (NA), for example, of 0.37, collects fluorescence along the Y-axis from the ions and maps each ion onto a multi-channel photo-multiplier tube (PMT) 110 for measurement of individual ions. Non-copropagating Raman laser beams from a laser 112, which are provided along the X-axis, perform operations on the ions. A diffractive beam splitter 114 creates an array of static Raman beams 116 that are individually switched using a multi-channel acousto-optic modulator (AOM) 118 and is configured to selectively act on individual ions. A global Raman laser beam 120 illuminates all ions at once. The system controller (also referred to as a “RF controller”) 104 controls the AOM 118 and thus controls laser pulses to be applied to trapped ions in the ion chain 106. The system controller 104 includes a central processing unit (CPU) 122, a read-only memory (ROM) 124, a random access memory (RAM) 126, a storage unit 128, and the like. The CPU 122 is a processor of the system controller 104. The ROM 124 stores various programs and the RAM 126 is the working memory for various programs and data. The storage unit 128 includes a nonvolatile memory, such as a hard disk drive (HDD) or a flash memory, and stores various programs even if power is turned off. The CPU 122, the ROM 124, the RAM 126, and the storage unit 128 are interconnected via a bus 130. The system controller 104 executes a control program which is stored in the ROM 124 or the storage unit 128 and uses the RAM 126 as a working area. The control program will include software applications that include program code that may be executed by processor in order to perform various functionalities associated with receiving and analyzing data and controlling any and all aspects of the methods and hardware used to create the ion trap quantum computer system 100 discussed herein.

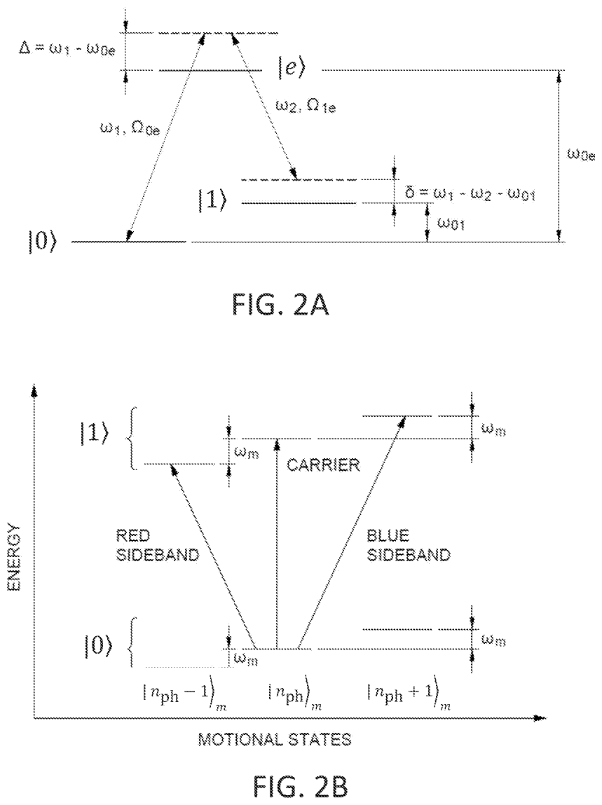

FIG. 2A depicts a schematic energy diagram of each ion in the ion chain 106 according to one embodiment. In one example, each ion may be a positive Ytterbium ion, ¹⁷¹Yb⁺, which has the ²S_{1/2} hyperfine states (i.e., two electronic states) with an energy split corresponding to a frequency difference (referred to as a “carrier frequency”) of ω₀₁/2π=12.6 GHz. A qubit is formed with the two hyperfine states, used to represent computational basis |0 [symbol] and |1 [symbol] (|i [symbol] (i∈Z)), where the hyperfine ground state (i.e., the lower energy state of the ²S_{1/2} hyperfine states) is chosen to represent |0 [symbol] . Hereinafter, the terms “hyperfine states,” “internal hyperfine states,” and “qubit states” may be interchangeably used to represent computational basis states |0 [symbol] and |1 [symbol] (|i [symbol] (i∈Z)). Each ion may be cooled (i.e., kinetic energy of the ion may be reduced) to near the motional ground state |0 [symbol] ₘ for any motional mode m with no phonon excitation (i.e., nₚₕ=0) by known laser cooling methods, such as Doppler cooling or resolved sideband cooling, and then the qubit state prepared in the hyperfine ground state |0 [symbol] by optical pumping. Here, |0 [symbol] represents the individual qubit state of a trapped ion whereas |0 [symbol] ₘ with the subscript m denotes the motional ground state for a motional mode m of the ion chain 106.

An individual qubit state of each trapped ion may be manipulated by, for example, a mode-locked laser at 355 nanometers (nm) via the excited ²P_{1/2} level (denoted as |e [symbol] [symbol] ). As shown in FIG. 2A, a laser beam from the laser may be split into a pair of non-copropagating laser beams (a first laser beam with frequency ω₁ and a second laser beam with frequency ω₂) in the Raman configuration, and detuned by a one-photon transition detuning frequency Δ=ω₁−ω₀ₑ with respect to the transition frequency ω₀e between |0 [symbol] and |e [symbol] , as illustrated in FIG. 2A. A two-photon transition detuning frequency δ includes adjusting the amount of energy that is provided to the trapped ion by the first and second laser beams, which when combined is used to cause the trapped ion to transfer between the hyperfine states |0 [symbol] and |1 [symbol] . When the one-photon transition detuning frequency Δ is much larger than a two-photon transition detuning frequency (also referred to simply as “detuning frequency”) δ=ω₁−ω₂−ω₀₁ (hereinafter denoted as ±μ, μ being a positive value), single-photon Rabi frequencies Ω₀ₑ(t) and Ω₁ₑ(t) (which are time-dependent, and are determined by amplitudes and phases of the first and second laser beams), at which Rabi flopping between states |0 [symbol] and |e [symbol] and between states |1 [symbol] and |e [symbol] respectively occur, and a spontaneous emission rate from the excited state |e [symbol] , Rabi flopping between the two hyperfine states |0 [symbol] and |1 [symbol] (referred to as a “carrier transition”) is induced at the two-photon Rabi frequency Ω(t). The two-photon Rabi frequency Ω(t) has an intensity (i.e., absolute value of amplitude) that is proportional to Ω₀ₑΩ₁ₑ/2Δ, where Ω₀ₑ and Ω₁ₑ are the single-photon Rabi frequencies due to the first and second laser beams, respectively. Hereinafter, this set of non-copropagating laser beams in the Raman configuration to manipulate internal hyperfine states of qubits (qubit states) may be referred to as a “composite pulse” or simply as a “pulse,” and the resulting time-dependent pattern of the two-photon Rabi frequency Ω(t) may be referred to as an “amplitude” of a pulse or simply as a “pulse,” which are illustrated and further described below. The detuning frequency δ=ω₁−ω₂−ω₀₁ may be referred to as detuning frequency of the composite pulse or detuning frequency of the pulse. The amplitude of the two-photon Rabi frequency Ω(t), which is determined by amplitudes of the first and second laser beams, may be referred to as an “amplitude” of the composite pulse.

It should be noted that the particular atomic species used in the discussion provided herein is just one example of atomic species which has stable and well-defined two-level energy structures when ionized and an excited state that is optically accessible, and thus is not intended to limit the possible configurations, specifications, or the like of an ion trap quantum computer according to the present disclosure. For example, other ion species include alkaline earth metal ions (Be⁺, Ca⁺, Sr⁺, Mg⁺, and Ba⁺) or transition metal ions (Zn⁺, Hg⁺, Cd⁺).

FIG. 2B depicts a schematic motional sideband spectrum of each ion in the ion chain 106 in a motional mode |nₚₕ [symbol] _{M} having frequency ωₘ according to one embodiment. As illustrated in FIG. 2B, when the detuning frequency of the composite pulse is zero (i.e., a frequency difference between the first and second laser beams is tuned to the carrier frequency, δ=ω₁−ω₂−ω₀₁=0), simple Rabi flopping between the qubit states |0 [symbol] and |1 [symbol] (carrier transition) occurs. When the detuning frequency of the composite pulse is positive (i.e., the frequency difference between the first and second laser beams is tuned higher than the carrier frequency, δ=ω₁−ω₂−ω₀₁=μ>0, referred to as a blue sideband), Rabi flopping between combined qubit-motional states |0 [symbol] |nₚₕ [symbol] ₘ and |1 [symbol] |nₚₕ+1), occurs (i.e., a transition from the m-th motional mode with n-phonon excitations denoted by |nₚₕ [symbol] ₘ to the m-th motional mode with (nₚₕ+1)-phonon excitations denoted by |nₚₕ+1 [symbol] ₘ occurs when the qubit state |0 [symbol] flips to |1 [symbol] ). When the detuning frequency of the composite pulse is negative (i.e., the frequency difference between the first and second laser beams is tuned lower than the carrier frequency by the frequency ωₘ of the motional mode |nₚₕ [symbol] ₘ, δ=ω₁−ω₂−ω₀₁=−μ<0, referred to as a red sideband), Rabi flopping between combined qubit-motional states |0 [symbol] |nₚₕ [symbol] ₘ and |1 [symbol] |nₚₕ−1 [symbol] ₘ occurs (i.e., a transition from the motional mode |nₚₕ [symbol] ₘ to the motional mode |nₚₕ−1 [symbol] , with one less phonon excitations occurs when the qubit state |0) flips to |1 [symbol] ). A π/2-pulse on the blue sideband applied to a qubit transforms the combined qubit-motional state |0 [symbol] |nₚₕ [symbol] ₘ into a superposition of |0 [symbol] |nₚₕ [symbol] ₘ and |1 [symbol] |nₚₕ+1 [symbol] ₘ. A π/2-pulse on the red sideband applied to a qubit transforms the combined qubit-motional |0 [symbol] |nₚₕ [symbol] ₘ into a superposition of |0 [symbol] |nₚₕ [symbol] ₘ and |1 [symbol] |nₚₕ−1 [symbol] ₘ. When the two-photon Rabi frequency Ω(t) is smaller as compared to the detuning frequency δ=ω₁−ω₂−ω₀₁=±μ, the blue sideband transition or the red sideband transition may be selectively driven. Thus, qubit states of a qubit can be entangled with a desired motional mode by applying the right type of pulse, such as a π/2-pulse, which can be subsequently entangled with another qubit, leading to an entanglement between the two qubits that is needed to perform an XX-gate operation in an ion trap quantum computer.

### Hybrid Quantum-Classical Computing System

While currently available quantum computers may be noisy and prone to errors, a combination of both quantum and classical computers, in which a quantum computer is a domain-specific accelerator, may be able to solve optimization problems that are beyond the reach of classical computers. In such optimization problems, the quantum approximate optimization algorithm (QAOA) is used to perform search for optimal solutions from a set of possible solutions according to some given criteria, using a quantum computer and a classical computer. The combinatorial optimization problems that can be solved by the methods described herein may include a combinatorial optimization problem with inequality constrains.

A combinatorial optimization problem is modeled by an objective function (also referred to as a “cost function”) that maps events or values of one or more variables onto real numbers representing “cost” associated with the events or values and seeks to minimize the cost function. In some cases, the combinatorial optimization problem may seek to maximize the objective function. The combinatorial optimization problem is further mapped onto a simple physical system described by a model Hamiltonian (corresponding to the sum of kinetic energy and potential energy of all particles in the system) and the problem seeks a low-lying energy state of the physical system.

This hybrid quantum-classical computing system has at least the following advantages. First, an initial guess is derived from a classical computer, and thus the initial guess does not need to be constructed in a quantum processor that may not be reliable due to inherent and unwanted noise in the system. Second, a quantum processor performs a small-sized (e.g., between a hundred qubits and a few thousand qubits) but accelerated operation (that can be performed using a small number of quantum logic gates) between an input of a guess from the classical computer and a measurement of a resulting state, and thus a NISQ device can execute the operation without accumulating errors. Thus, the hybrid quantum-classical computing system may allow challenging problems to be solved, such as small but challenging combinatorial optimization problems, which are not practically feasible on classical computers, or suggest ways to speed up the computation with respect to the results that would be achieved using the best-known classical algorithm.

Typically, the optimization problem with an inequality constraint g(x)=Σᵢ₌₁ⁿlᵢxᵢ−B≤0 (for n variables xᵢ, i=1, 2, . . . , n) is solved by converting the inequality constraint to an equality constraint h(x)−Σₖ₌₀^{N-1}2^{k}sₖ=0 with nearly introduced slack variables sₖ. The number N of the slack variables sₖ needed is

$$N = ⌈ {log}_{2} ( {max}_{x} {\sum }_{i = 1}^{n} {l}_{i} {x}_{i} - B ) ⌉ ,$$

which grows with the number n of variables xᵢ and the inequality constraint B. In cases the optimization problem includes more than one inequality constraints, each inequality constraint introduces one set of slack variables sₖ. In mapping of the optimization problem onto a quantum processor, the number of qubits required to represent the optimization problem is equal to the total number n of variables xᵢ and the number of N the slack variables sₖ. The number of qubits can grow quickly and varies depending on the inequality constrains B due to the number N of slack variables sₖ needed to encode the inequality constraints.

Thus, in the embodiments described herein, the inequality constraints are introduced without the use of slack variables sₖ. The inequality constraints are embedded in the optimization problem using a polynomial approximation to the Heaviside step function

$$Θ ( x ) = \{ \begin{matrix}1 , & x > 0 \\ 0 , & x \leq 0\end{matrix} .$$

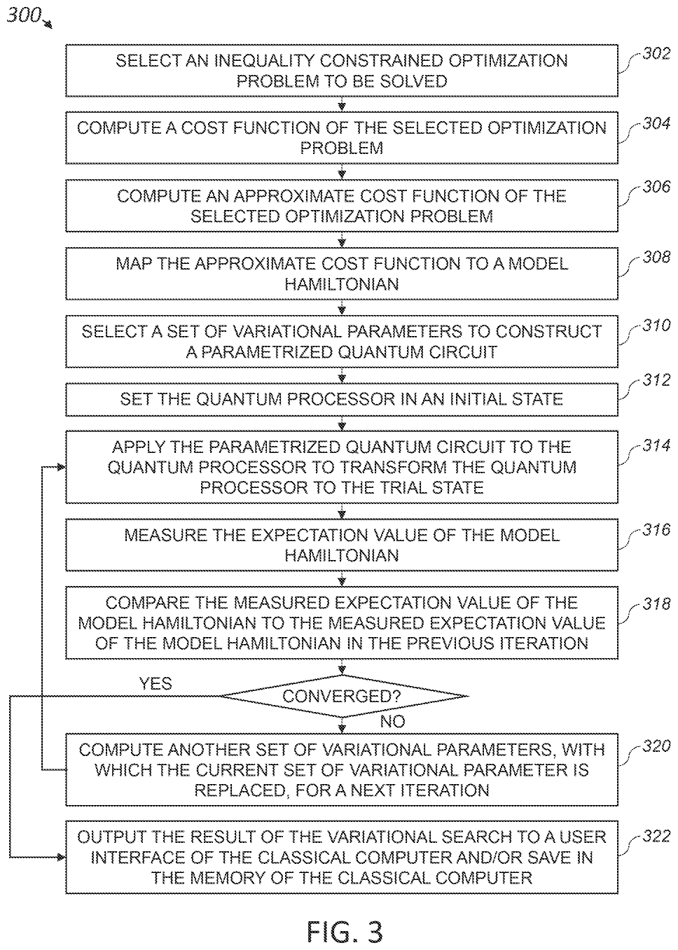

FIG. 3 depicts a flowchart illustrating a method 300 of obtaining a solution to an inequality constrained optimization problem by a quantum variational method, such as the quantum approximate optimization algorithm (QAOA), according to one embodiment. In this example, a quantum processor is the ion chain 106 of n trapped ions, in which the two hyperfine states of each of the n trapped ions form a qubit, for example, the hyperfine ground state representing qubit state |0 [symbol] and the hyperfine excited state representing qubit state |1 [symbol] .

A quantum variational method, such as the QAOA, relies on a variational search by the well-known Rayleigh-Ritz variational principle. The variational method consists of iterations that include choosing a “trial state” of the quantum processor depending on a set of one or more parameters (referred to as “variational parameters”) and measuring an expectation value of the model Hamiltonian (e.g., energy) of the trial state. A set of variational parameters (and thus a corresponding trial state) is adjusted and an optimal set of variational parameters is found that minimizes the expectation value of the model Hamiltonian (e.g., the energy). The resulting expectation value (e.g., the energy) approximates the exact lowest energy of the model Hamiltonian.

The method 300 begins with block 302, in which, by a classical computer, such as the classical computer 102, an optimization problem with variables xᵢ(i=1, 2, . . . , n) constrained by one or more inequality constraints to be solved by a quantum variational method is selected, for example, by use of a user interface of the classical computer, or retrieved from the memory of the classical computer. An inequality constrained optimization problem may be to minimize:

$$f ( x ) = {\sum }_{i = 1}^{n - 1} {\sum }_{j > i}^{n} {q}_{ij} {x}_{i} {x}_{j} + {\sum }_{i = 1}^{n} {q}_{ii} {x}_{i} ,$$

subject to one or more inequality constrains:

$$g ( x ) = {\sum }_{i = 1}^{n} {l}_{i} {x}_{i} - B \leq 0 , {l}_{i} ∈ ℝ ,$$

where x is a vector value having n variables x; (i=1, 2, . . . , n). The optimization problem may include one or more equality constraints:

$$h ( x ) = {\sum }_{i = 1}^{n} {c}_{i} {x}_{i} - C = 0 , {c}_{i} ∈ ℝ .$$

Examples of inequality constrained optimization problems include the knapsack problem, which determines, given a set of items, each with a weight and a value, which items to include in the collection so that the total weight is less than or equal to a given limit and the total value is as large as possible. In the example of the knapsack problem with 5 variables, f(x)=Σᵢ₌₁⁵ vᵢxᵢ is to be maximized, subject to an inequality constraint:

$$h ( x ) = {\sum }_{i = 1}^{5} {w}_{i} {x}_{i} - W \leq 0 , {x}_{i} ∈ \{ 0 , 1 \} .$$

In block 304, by the classical computer 102, a cost function L(x, λ₀, λ₁) that is to be minimized to solve the selected inequality constrained optimization problem is computed. The cost function L(x, λ₀, λ₁) is computed as:

$$L ( x , {λ}_{0} , {λ}_{1} ) = f ( x ) + {λ}_{0} Θ [ g ( x ) ] + {{λ}_{1} [ h ( x ) ]}^{2} ,$$

where Θ(x) is the Heaviside step function

$$Θ ( x ) = \{ \begin{matrix}1 , & x > 0 \\ 0 , & x \leq 0\end{matrix} .$$

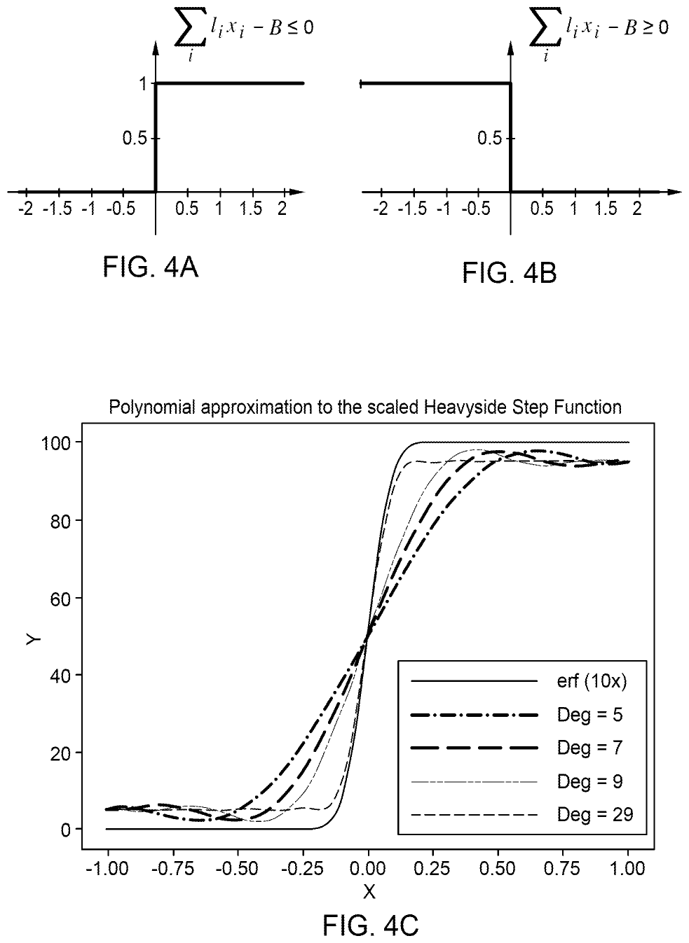

The Heaviside step function Θ(x) is scaled by a penalty value λ₀ for violating the inequality constraint, which can be set depending on the optimization problem. The Heaviside step function Θ(x) can be applied depending on whether the inequality constraint involves ≤ (as shown in FIG. 4A) or ≥ (as shown in FIG. 4B). For example, the inequality constraint g(x)=Σᵢ₌₁ⁿ lᵢxᵢ−B≤0 can be included as [g(x)] in the cost function (x, λ₀, λ₁) after scaling g(x) appropriately such that g(x) lies between −1 and 1.

In block 306, by the classical computer 102, an approximate cost function \tilde{L}(x, λ₀, λ₁) is computed. In the approximate cost function L(x, λ₀, λ₁), an odd degree 2k+1 polynomial approximation \tilde{Θ}(x)=Σᵢ₌₁^{k}pᵢx²ⁱ⁺¹ (including odd order polynomials pox, p₁x³, p₂x⁵, . . . , pₖx^{2k+1}) of the Heaviside step function Θ(x) is used. Polynomial approximations of different degrees 2k+1 are shown in FIG. 4C. As seen in FIG. 4C, a polynomial approximation of a higher degree 2k+1 produces a curve that is closer to the error function

$$erf x = \frac{2}{\sqrt{π}} {\int }_{0}^{x} {e}^{- {t}^{2}} dt ,$$

which is close the Heaviside step function Θ(x).

In block 308, by the classical computer 102, the approximate cost function \tilde{L}(x, λ₀, λ₁) is mapped onto a model Hamiltonian H_{C} to be implemented on the quantum processor, by mapping the variables xᵢ(i=1, 2, . . . , n) to the Ising number operator \hat{n}ᵢ(i=1, 2, . . . , n) as

$${x}_{i} = {\hat{n}}_{i} = \frac{1 - {Z}_{i}}{2}$$

where Zᵢ is the Pauli Z operator. The quantum processor has n qubits and each number operator \hat{n}ᵢ(i=1, 2, . . . , n) is encoded in qubit i(i=1, 2, . . . , n) in the quantum processor. For example, the states where the number operator \hat{n}ᵢ is 0 and 1 are encoded as |0 [symbol] and |1) of the qubit i, respectively. Here, the number of variables xᵢ(i=1, 2, . . . , n) equals the number of qubits i(i=1, 2, . . . , n) required to implement the approximate cost function \tilde{L}(x, λ₀, λ₁).

Minimizing the approximate cost function \tilde{L}(x, λ₀, λ₁) is now converted to finding a low-lying energy state of the model Hamiltonian H_{C}:

$$\begin{matrix}{H}_{C} = {H}_{f} + {λ}_{0} {\tilde{H}}_{g} + {λ}_{1} {H}_{h} , \\ {H}_{f} = {\sum }_{i = 1}^{n - 1} {\sum }_{j > i}^{n} {q}_{ij} {\hat{n}}_{i} {\hat{n}}_{j} + {\sum }_{i = 1}^{n} {q}_{ii} {\hat{n}}_{i} \\ {\tilde{H}}_{g} = {\sum }_{p = 1}^{k} {c}_{p} {B}^{2 p + 1} + {\sum }_{p = 1}^{n} {c}_{p} {\hat{n}}_{p} + {\sum }_{p = 1}^{n} {\sum }_{q = p + 1}^{n} {c}_{pq} {\hat{n}}_{p} {\hat{n}}_{q} + {\sum }_{p = 1}^{n} {\sum }_{q = p + 1}^{n} {\sum }_{r = q + 1}^{n} {c}_{pqr} {\hat{n}}_{p} {\hat{n}}_{q} {\hat{n}}_{r} + … , \\ {H}_{h} = {{λ}_{1} [ {\sum }_{i = 1}^{n} {c}_{i} {\hat{n}}_{i} - C ]}^{2} ,\end{matrix}$$

where H_{f} and Hₕ are the model Hamiltonians converted from the terms f(x) and λ₁[h(x)]² in the cost function cost function L(x, λ₀, λ₁), respectively. Here, \tilde{H}_{g} is the model Hamiltonian converted from the approximate term λ₀\hat{Θ}[g(x)] corresponding to the inequality constraint in the approximate cost function L(x, λ₀, λ₁), and each term includes a product of up to (2k+1) number operators \hat{n}ᵢ(i=1, 2, . . . , n), where 2k+1 is the degree of the polynomial approximation of the Heaviside step function Θ(x). Further, Hg can be expressed in terms of the Pauli Z operators as:

$${H}_{g} = {\sum }_{p = 1}^{k} {c}_{p} {B}^{2 p + 1} + {\sum }_{p = 1}^{n} {c}_{p} {Z}_{p} + {\sum }_{p = 1}^{n} {\sum }_{q = p + 1}^{n} {c}_{pq} {Z}_{p} {Z}_{q} + {\sum }_{p = 1}^{n} {\sum }_{q = p + 1}^{n} {\sum }_{r = q + 1}^{n} {c}_{pqr} {Z}_{p} {Z}_{q} {Z}_{r} + … ,$$

where the first term Σₚ₌₁^{k} cₚB^{2p+1} is simply an offset in the model Hamiltonian H_{C} that can be ignored. The number of terms containing the Pauli Z operators Zᵢ in each sum in \tilde{H}g is:

$$( \begin{matrix}n \\ p\end{matrix} ) = \frac{n !}{( n - p ) ! p !} ,$$

where p goes from 1 to min(n, k). The maximum number of Pauli Z operators Zᵢ in any term in the expansion is min(n, k) for a 2k+1 degree of the polynomial approximation of the Heaviside step function Θ(x) because \hat{n}ᵢ^{m}=\hat{n}ᵢ for any integer m≥1. Any number of inequality constraints can be embedded similarly, since all the terms of the same degree 2k+1 of the polynomial approximation of the Heaviside step function Θ(x) from different inequality constraints add up. The sum of all inequality constraints embedded this way is added to the cost function L(x, λ₀, λ₁) along with any equality constraints as in λ₁[h(x)]².

In the example of the knapsack problem with 5 variables, the term \tilde{H}_{g} corresponding to the inequality constraint in the model Hamiltonian H_{C} includes 5 terms with a single Pauli Z operator, which can be implemented on the quantum computer by single qubit rotations and typically do not contribute to circuit depth, 10 terms with two Pauli Z operators (Z₅Z₄, Z₅Z₃, Z₅Z₂, Z₅Z₁, Z₄Z₃, Z₄Z₂, Z₄Z₁, Z₃Z₂, Z₃Z₁, Z₂Z₁), 10 terms with three Pauli Z operators (Z₅Z₄Z₃, Z₅Z₄Z₂, Z₅Z₄Z₁, Z₅Z₃Z₂, Z₅Z₃Z₁, Z₅Z₂Z₁, Z₄Z₃Z₂, Z₄Z₃Z₁, Z₄Z₂Z₁, Z₃Z₂Z₁), 5 terms with four Pauli Z operators (Z₅Z₄Z₃Z₂, Z₅Z₄Z₃Z₁, Z₅Z₄Z₂Z₁, Z₅Z₃Z₂Z₁, Z₄Z₃Z₂Z₁), and 1 term with 5 Pauli Z operators (Z₅Z₄Z₃Z₂Z₁).

In block 310, by the classical computer 102, a set of variational parameters (γ=γ₁, γ₂, . . . , γₚ, \vec{β}=β₁, β₂, . . . , βₚ) is selected to construct a sequence of gates (also referred to a “parametrized quantum circuit”) A(γ, β), which prepares the quantum processor in a trial state |ψ(\vec{γ}, \vec{β}) [symbol] . For the initial iteration, a set of variational parameters (\vec{γ}, \vec{β}) may be randomly chosen for the initial iteration. This trial state |ψ(\vec{γ}, \vec{β}) [symbol] is used to provide an expectation value of the model Hamiltonian H_{C}. The trial state preparation circuit A(\vec{γ}, \vec{β}) includes p layers (i.e., p-time repetitions) of an entangling circuit U(γₗ) that relates to the model Hamiltonian H_{C}(U(γₗ)=e^{-iγ}^{ₗ}^{H}^{_{C}}) and a mixing circuit U_{Mix}(βₗ) that relates to a mixing term H_{B}=Σᵢ₌₂ⁿ Xᵢ (U_{Mix}(βₗ)=e^{-iβ}^{ₗ}^{H}^{_{B}}) (l=1, 2, . . . , p) as

$$A ( \vec{γ} , \vec{β} ) = {U}_{Mix} ( {β}_{p} ) {U}_{Mix} ( {β}_{p - 1} ) U ( {γ}_{p - 1} ) … {U}_{Mix} ( {β}_{1} ) U ( {γ}_{1} . )$$

Each term Xᵢ in the mixing term H_{B} corresponds to a π/2-pulse applied to qubit i in the quantum processor.

The entangling circuit U(γₗ) that relates to the model Hamiltonian H_{C} (U(γₗ)=e^{-iγ}^{ₗ}^{H}^{_{C}}) may be converted to a product of exponential terms, referred to as Trotter terms by the technique of the Trotter product formula known in the art.

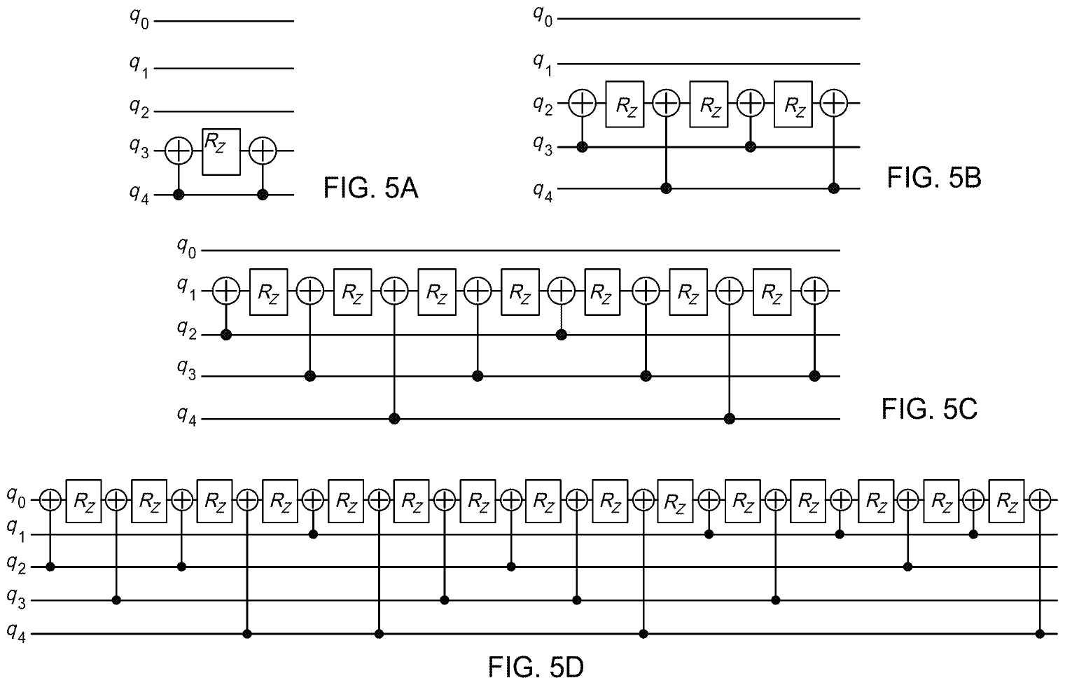

In the example of the knapsack problem with 5 variables, the term including Z₅Z₄ can be implemented using 2 C-NOT gates and one single qubit rotation gate R_{Z}, as shown in FIG. 5A. The terms including Z₄Z₃, Z₅Z₄Z₃, and Z₅Z₃ combined can be implemented using 4 C-NOT gates and 3 single qubit rotation gates R_{Z}, as shown in FIG. 5B, although 8 C-NOT gates are required if those terms are implemented individually (without being combined). The terms including Z₃Z₂, Z₄Z₃Z₂, Z₅Z₄Z₃Z₂, Z₅Z₃Z₂, Z₅Z₂, Z₅Z₄Z₂, and Z₄Z₂ combined can be implemented using 8 C-NOT gates and 7 single qubit rotation gates R_{Z}, as shown in FIG. 5C, although 24 C-NOT gates are required if those terms are implemented individually (without being combined). The terms Z₃Z₁, Z₄Z₃Z₁, Z₄Z₁, Z₅Z₄Z₁, Z₅Z₄Z₂Z₁, Z₂Z₁, Z₃Z₂Z₁, Z₄Z₃Z₂Z₁, Z₅Z₄Z₃Z₁, Z₅Z₃Z₁, Z₅Z₃Z₂Z₁, Z₅Z₂Z₁, and Z₅Z₁ combined can be implemented using 16 C-NOT gates and 15 single qubit rotation gates R_{Z}, as shown in FIG. 5D, although 64 C-NOT gates are required if those terms are implemented individually (without being combined). Other combinations are also possible. Heuristic methods for circuit compilation and reduction can also be used.

In block 312, by a system controller, such as the system controller 104, the quantum processor is set in an initial state |ψ₀). In some embodiments, the initial state |ψ₀) may be in the hyperfine ground state of the quantum processor (in which all qubits are in the uniform superposition over computational basis states (in which all qubits are in the superposition of |0 [symbol] and |1 [symbol] , |0 [symbol] +|1 [symbol] ). In some other embodiments, the initial state |ψ₀ [symbol] is prepared in a superposition of states, one of which corresponds to the ground state of the model Hamiltonian H_{C}.

In block 314, by the system controller, the parametrized quantum circuit A(\vec{γ}, \vec{β}) is applied to the quantum processor to transform the quantum processor to the trial state |ψ(\vec{γ}, \vec{β} [symbol] ) for evaluating an expectation of the model Hamiltonian H_{C}.

In block 316, by the system controller, the expectation value F(\vec{γ}, \vec{β})= [symbol] ψ(\vec{γ}, \vec{β})|H_{C}|ψ(\vec{γ}, \vec{β} [symbol] ) of the model Hamiltonian H_{C} is measured. Repeated measurements of populations of the trapped ions in the ion chain 106 in the trial state |ψ(\vec{γ}, \vec{β} [symbol] ), by collecting fluorescence from each trapped ion and mapping onto the PMT 110, yield the expectation value the model Hamiltonian H_{C}.

In block 318, the measured expectation value F(\vec{γ}, \vec{β}) of the model Hamiltonian H_{C} is compared to the measured expectation value of the model Hamiltonian H_{C} in the previous iteration, by the classical computer 102. If a difference between the two values (referred to as a residual) is less than a predetermined value (i.e., the expectation value sufficiently converges towards a fixed value), the method proceeds to block 322. If the difference between the two values is more than the predetermined value, the method proceeds to block 320.

In block 320, another set of variational parameters (\vec{γ}, \vec{β}), with which the current set of variational parameter (\vec{γ}, \vec{β}) is replaced, for a next iteration of blocks 314 to 318 is computed by the classical computer 102, in search for an optimal set of variational parameters (\vec{γ}, \vec{β}) to minimize the expectation value of the model Hamiltonian H_{C}, F(\vec{γ}, \vec{β})= [symbol] ψ(\vec{γ}, \vec{β})|H_{C}|ψ(\vec{γ}, \vec{β} [symbol] ). That is, the classical computer 102 executes a classical optimization method to find the optimal set of variational parameters

$$( \vec{γ} , \vec{β} ) ( {min}_{\vec{γ} , \vec{β}} F ( \vec{γ} , \vec{β} ) ) .$$

Examples of conventional classical optimization methods include simultaneous perturbation stochastic approximation (SPSA), particle swarm optimization (PSO), Bayesian optimization (BO), and Nelder-Mead (NM).

In block 322, the result of the variational search is outputted, by the classical computer 102, to a user interface of the classical computer 102 and/or saved in the memory of the classical computer 102. The final results of the variational search includes the measured expectation value of the model Hamiltonian H_{C} in the final iteration corresponding to the minimized value of the objective function L(x, λ₀, λ₁) and the measurement of the trail state |ψ(\vec{γ}, \vec{β} [symbol] ) in the final iteration corresponding to the solutions to the inequality constrained optimization problem.

In the method for obtaining a solution to an inequality constrained optimization problem on a hybrid quantum-classical computing system described herein provides advantages over the conventional method for solving an inequality constrained optimization problem. Firstly, the number of qubits required to map an inequality constrained optimization problem on a quantum processor is determined by the number of variables in the inequality constrained optimization problem. Since the use of slack variables that are commonly used for solving an inequality constrained optimization problem is eliminated, no additional qubits to represent such slack variables are required. Secondly, the number of terms in a model Hamiltonian, to which a cost function of the inequality constrained optimization problem, is bounded by a degree of the polynomial approximation of the Heaviside step function that describes the inequality constraint. Thus, the number of terms in the model Hamiltonian does not grow with a problem size (i.e., the number of variables in the inequality constrained optimization problem). Lastly, the number of qubits or the number of terms in the model Hamiltonian does not depend on the number of inequality constraints or values that are included in the inequality constraints.

While the foregoing is directed to specific embodiments, other and further embodiments may be devised without departing from the basic scope thereof, and the scope thereof is determined by the claims that follow.

1. A method of performing computation in a hybrid quantum-classical computing system comprising a classical computer and a quantum processor, comprising:
computing, by a classical computer, an approximate cost function of an optimization problem with variables constrained by an inequality, wherein the inequality constraint is included using a polynomial approximation of a Heaviside step function;
mapping, by the classical computer, the approximate cost function of the optimization problem to a model Hamiltonian to be implemented on a quantum processor comprising a plurality of trapped ions, each of which has two hyperfine states defining a qubit;
selecting, by the classical computer, a set of variational parameters to construct a parametrized quantum circuit comprising an entangling circuit based on the model Hamiltonian and a mixing circuit;
setting, by a system controller, the quantum processor in an initial state;
executing one or more iterations, each iteration comprising:
applying, by the system controller, the parametrized quantum circuit to the quantum processor based on the set of the variational parameters and the model Hamiltonian, to transform the quantum processor to a trial state;
measuring, by the system controller, an expectation value of the model Hamiltonian; and
replacing, by the classical computer, the set of the variational parameters with another set of variational parameters, if a difference between the measured expectation value of the model Hamiltonian and the expectation value of the model Hamiltonian measured in a previous iteration is more than a predetermined value; and
outputting, by the classical computer, the set of the variational parameters after executing the one or more iterations.

2. The method of claim 1, wherein the optimization problem is a knapsack problem.

3. The method of claim 1, wherein a number of the variables equals a number of the plurality of trapped ions.

4. The method of claim 1, wherein the polynomial approximation of the Heaviside step function includes odd order polynomials.

5. The method of claim 4, wherein the maximum number of terms in the model Hamiltonian is the highest order of polynomials in the polynomial approximation of the Heaviside step function.

6. The method of claim 1, wherein the optimization problem is further constrained by one or more equalities.

7. The method of claim 1, wherein the optimization problem is further constrained by one or more additional inequalities.

8. A hybrid quantum-classical computing system, comprising:
a quantum processor comprising a plurality of trapped ions, each of the trapped ions having two hyperfine states defining a qubit;
one or more lasers configured to emit a laser beam, which is provided to trapped ions in the quantum processor; and
a classical computer configured to:
compute an approximate cost function of an optimization problem with variables constrained by an inequality, wherein the inequality constraint is included using a polynomial approximation of a Heaviside step function;
map the approximate cost function of the optimization problem to a model Hamiltonian to be implemented on the quantum processor;
select a set of variational parameters to construct a parametrized quantum circuit comprising an entangling circuit based on the model Hamiltonian and a mixing circuit;
control a system controller to set the quantum processor in an initial state;
execute one or more iterations, each iteration comprising:
control the system controller to apply the parametrized quantum circuit to the quantum processor based on the set of the variational parameters and the model Hamiltonian, to transform the quantum processor to a trial state;
control the system controller to measure an expectation value of the model Hamiltonian; and
replace the set of the variational parameters with another set of variational parameters, if a difference between the measured expectation value of the model Hamiltonian and the expectation value of the model Hamiltonian measured in a previous iteration is more than a predetermined value; and
output the set of the variational parameters after executing the one or more iterations.

9. The hybrid quantum-classical computing system of claim 8, wherein each of the trapped ions is ¹⁷¹Yb⁺ having ²S_{1/2} hyperfine states.

10. The hybrid quantum-classical computing system of claim 8, wherein
each of the trapped ions is one selected from Be⁺, Ca⁺, Sr⁺, Mg⁺, Ba⁺, Zn⁺, Hg⁺, Cd⁺.

11. The hybrid quantum-classical computing system of claim 8, wherein the optimization problem is a knapsack problem.

12. The hybrid quantum-classical computing system of claim 8, wherein a number of the variables equals a number of the plurality of trapped ions.

13. The hybrid quantum-classical computing system of claim 8, wherein
the polynomial approximation of the Heaviside step function includes odd order polynomials, and
the maximum number of terms in the model Hamiltonian is the highest order of polynomials in the polynomial approximation of the Heaviside step function.

14. The hybrid quantum-classical computing system of claim 8, wherein the optimization problem is further constrained by one or more equalities.

15. The hybrid quantum-classical computing system of claim 8, wherein the optimization problem is further constrained by one or more additional inequalities.

16. A hybrid quantum-classical computing system comprising non-volatile memory having a number of instructions stored therein which, when executed by one or more processors, causes the hybrid quantum-classical computing system to perform operations comprising:
computing, by a classical computer, an approximate cost function of an optimization problem with variables constrained by an inequality, wherein the inequality constraint is included using a polynomial approximation of a Heaviside step function;
mapping, by the classical computer, the approximate cost function of the optimization problem to a model Hamiltonian to be implemented on a quantum processor comprising a plurality of trapped ions, each of which has two hyperfine states defining a qubit;
selecting, by the classical computer, a set of variational parameters to construct a parametrized quantum circuit comprising an entangling circuit based on the model Hamiltonian and a mixing circuit;
setting, by a system controller, the quantum processor in an initial state;
executing one or more iterations, each iteration comprising:
applying, by the system controller, the parametrized quantum circuit to the quantum processor based on the set of the variational parameters and the model Hamiltonian, to transform the quantum processor to a trial state;
measuring, by the system controller, an expectation value of the model Hamiltonian; and
replacing, by the classical computer, the set of the variational parameters with another set of variational parameters, if a difference between the measured expectation value of the model Hamiltonian and the expectation value of the model Hamiltonian measured in a previous iteration is more than a predetermined value; and
outputting, by the classical computer, the set of the variational parameters after executing the one or more iterations.

17. The hybrid quantum-classical computing system of claim 16, wherein the optimization problem is a knapsack problem.

18. The hybrid quantum-classical computing system of claim 16, wherein a number of the variables equals a number of the plurality of trapped ions.

19. The hybrid quantum-classical computing system of claim 16, wherein the polynomial approximation of the Heaviside step function includes odd order polynomials, and
maximum number of terms in the model Hamiltonian is the highest order of polynomials in the polynomial approximation of the Heaviside step function.

20. The hybrid quantum-classical computing system of claim 16, wherein the optimization problem is further constrained by one or more equalities, and the optimization problem is further constrained by one or more additional inequalities.
